(19) United States
(12) Patent Application Publication
(10) Pub. No.: US 2003/0138310 A1
(43) Pub. Date: Jul. 24, 2003

(54) Front end loader

(76) Inventor: Jason K. Lovett, Griffin, GA (US)

Correspondence Address: JASON K. LOVETT, 102 Fox Road, Griffin, GA, 30224, US

(21) Appl. No.: 10/052,956

(22) Filed: Jan. 23, 2002

(51) Int. Cl. B66F 11/00

(52) U.S. Cl. 414/685

(57) ABSTRACT

The specification relates to front end loader trailer adapted to lift dumpsters with varying slot heights. The trailer has tandem axles, allowing for greater support of the containers and the adjustable forks. The trailer has adjustable forks, which can be adjusted by changing a pin in the nest support frame. The change in forks length allows the trailer to pick up dumpsters with the slots at different heights on the dumpster. The trailer's nest support frame, pivot shaft and adjustable forks is powered by a 12 volt DC battery and a hydraulic power unit.

### BACKGROUND OF THE FRONT END LOADER

This invention is concerned with a new design on a trailer pulled behind a truck to pick up front load dumpster containers. Currently five or six manufacturers make a trailer that is single axle. However, it has not been possible with these trailers to adjust to the height of individual boxes. The Front End Loader allows greater stability and more flexibility. It has a tandem axle design for greater stability, which provides support for the adjustable forks. These forks or arms can be altered by moving the adjustment pin into a different hole in the arm, allowing the arms to pick up varying size dumpster containers. The object of the invention is to enable the trailer operator greater stability in picking up containers as the containers can now fit between two sets of wheels. Further, the object is to allow the operator to easily pick up containers with varying slot heights. Presently, there is no capability to adjust to slot heights, making the retrieval of containers a time consuming anf imprecise process.

### SUMMARY OF THE INVENTION

The Front End Loader is designed to allow the operator of a truck picking up dumpsters to pick up the container no matter where the slot handles are on the container and to do so with maximum stability. Previously, a trailer hauled behind a truck and used to lift front end load containers was only single axle and, thus, not very stable. In addition, the same earlier trailer could not adjust for the differing slot heights in the containers. With the Front End Loader, the Forks which slide into the Nest Support Frame can be adjusted by the use of the Adjustment Pins, so that the Fork can lift a container whose height may vary from seventy to eight inches. Thus, the operator lifting a front end load container is no longer facing the danger that the dumpster may fall over due to the slots of the container not corresponding adequately to the length of the Forks or due to the instability of the trailer with only single axles wheels. The object of the invention is to allow a trailer operator to hydraulically lift any front end container on the market today, which containers have varying slot heights from seventy to eighty inches.

### BRIEF DESCRIPTION OF THE DRAWINGS

FIG. 1 is a drawing of the Front End Loader. Item 1 is an adjustable fork weldment. Item 2 is a pivot shaft to lift the frame. Item 3 is a nest support frame. Item 4 is the adjustable pin. Item 5 is a 12 volt DC battery. Item 6 is the hydraulic cylinder. Item 7 is a trailer hand jack. Item 8 is the main frame trailer. Item 9 is the hydraulic power unit.

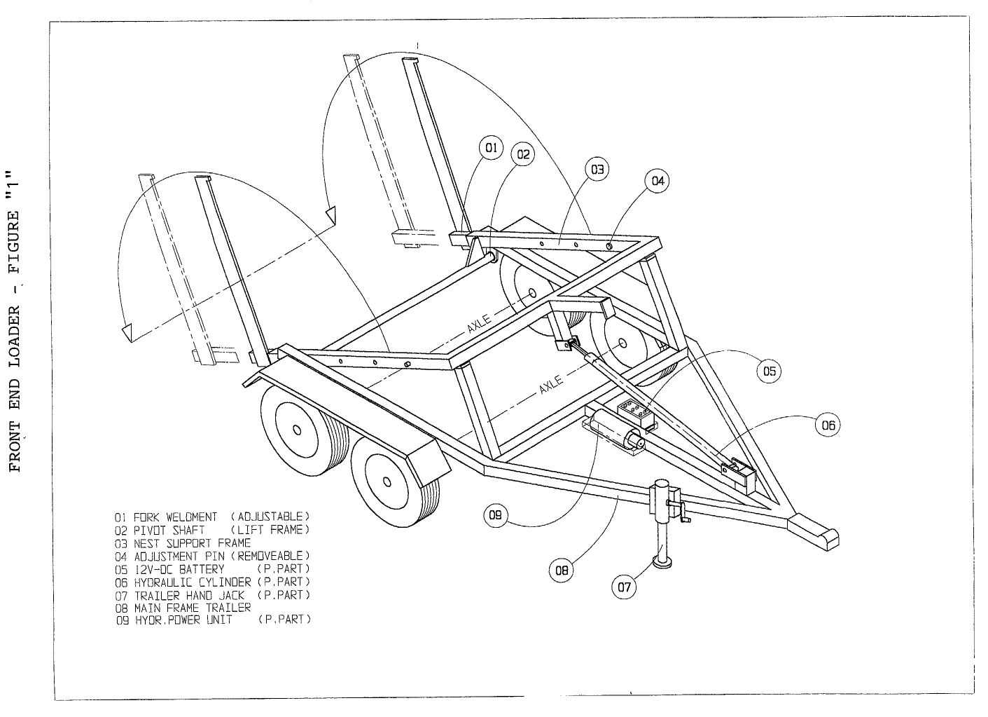

### DETAILED DESCRIPTION OF THE INVENTION

A first step in the process of the invention is to take a standard trailer with a trailer jack and add a second axle. The second step is to add the 12 volt DC battery and the hydraulic power unit to the front portion of the trailer main frame, directly below where the hydraulic cylinder will be placed. Next a nest support frame is placed onto the main frame trailer. The nest support frame is a U-shaped metal frame, consisting of three metal bars welded together at the perpendicular, creating a ninety-degree angle “U.” The nest support frame has four holes for placement of the adjustable pins. Next, the hydraulic cylinder is attached to the nest support frame. The hydraulic cylinder is a retractable metal cylinder with springs, which allows the nest support frame to be moved vertically. A pivot shaft is then placed between the two sides of the main frame trailer in the rear. This shaft supports the container and rotates with the nest support frame to move the container vertically. Finally the forks are attached to the nest support frame with fork weldments. The forks consist of two metal bars welded together at a ninety degree angles The vertical portion of the bar has at the top a crossbar to lift containers. The horizontal portion of the bar slides into the nest support frame and is secured to the frame by the adjustable pin. Thus, the horizontal bar also has four holes in which the adjustable pin may rest.

The Front End Loader weighs 800 pounds. The vertical portion of the forks is forty-eight inches. The width of the trailer is seventy-two inches. The overall length of the trailer with the forks up is twelve feet. The distance between the tires is ninety-six inches. The trailer has a capacity to lift dumpsters from seventy to eighty inches in height.

What is claimed is:

1. A trailer that picks up front load dumpster containers, which consists of a Main Frame Trailer, with a trailer hitch; on the arm of the frame which extends to the truck (“Arm”) is a trailer hand jack, a hydraulic power unit, and a 12 volt DC battery; connecting the Arm of the frame to a Nest Support Frame is a hydraulic cylinder for lifting the Nest Support Frame; the Nest Support Frame rests on the Main Frame Trailer just beyond the Arm and consists of four metal bars welded together at perpendicular angles and creating a square and two vertical metal bars supporting the Nest Support Frame onto the Main Frame Trailer; the Nest Support Frame includes a pivot shaft at the end of the trailer, a metal bar parallel to the pivot shaft next to the Arm, and two hollow side metal bars of the Nest Support Frame containing at least four holes for placing an Adjustable Pin; sliding into the hollow metal side bars of the Nest Support Frame are two Forks; each Fork has a fork weldment allowing the fork to pivot up to one hundred eighty degrees; each Fork also is composed of two bars connected by the fork weldment, with one half of the Fork fitting into the Nest Support Frame and being held by an Adjustable Pin and the other half of the Fork pivoting to lift dumpster containers.
